(19) United States
(12) Patent Application Publication
(10) Pub. No.: US 2021/0116183 A1
(43) Pub. Date: Apr. 22, 2021

(54) EXTENDED INLET SURFACES FOR ADDITIVE MANUFACTURED HEAT EXCHANGERS

(71) Applicant: Hamilton Sundstrand Corporation, Charlotte, NC (US)

(72) Inventors: Jeremy Clavette, West Hartford, CT (US); Rafael Alexander Izarra, West Simsbury, CT (US)

(21) Appl. No.: 16/655,461

(22) Filed: Oct. 17, 2019

(51) Int. Cl. F28D 9/00; B33Y 80/00

(52) U.S. Cl. CPC F28D 9/0093; F28F 2245/00; B33Y 80/00

(57) ABSTRACT

A heat exchanger includes a first layer, a second layer, and a third layer. The first layer includes a first width W₁ extending in a first direction and a first length L₁ extending in a second direction. The second layer includes a second length L₂ extending in the first direction and a second width W₂ extending in the second direction. The third layer includes a third width W₃ extending in the first direction and a third length L₃ extending in a second direction. The second layer is between the first layer and the third layer. The first length L₁ of the first layer and the third length L₃ of the third layer both extend further in the second direction than the second width W₂ of the second layer. The first layer and the third layer include an overhang.

### BACKGROUND

The present disclosure relates to heat exchangers, and, in particular, heat exchangers with a cross-flow configuration.

Heat exchangers aim to transfer heat between a hot fluid and a cool fluid. To increase the efficiency of heat exchangers, walls and fins are utilized to increase the surface area through which thermal energy can transfer. In cross-flow heat exchangers, pressure loss occurs as the hot fluid or the cold fluid flow through their respective layer. Pressure loss can decrease the overall effectiveness of the heat exchanger. Additionally, cross-flow heat exchangers can experience increased transient thermal stresses from pockets of hot air near layer inlets.

### SUMMARY

In one embodiment of the present disclosure, A heat exchanger includes a first layer, a second layer, and a third layer. The first layer includes a first width W₁ extending in a first direction and a first length L₁ extending in a second direction. The second layer includes a second length L₂ extending in the first direction and a second width W₂ extending in the second direction. The third layer includes a third width W₃ extending in the first direction and a third length L₃ extending in a second direction. The second layer is between the first layer and the third layer. The first length L₁ of the first layer and the third length L₃ of the third layer both extend further in the second direction than the second width W₂ of the second layer. The first layer and the third layer include an overhang.

In another embodiment of the present disclosure, a heat exchanger includes a first layer, a second layer, and a third layer. The first layer includes a first width W₁ extending in a sinusoidal shape in a first direction and a first length L₁ extending in a sinusoidal shape in a second direction. The second layer includes a second length L₂ extending in a sinusoidal shape in the first direction and a second width W₂ extending in a sinusoidal shape in the second direction. The third layer includes a third width W₃ extending in a sinusoidal shape in the first direction and a third length L₃ extending in a sinusoidal shape in the second direction. The second layer is between the first layer and the third layer. The first length L₃ of the first layer and the third length L₃ of the third layer both extend further in the second direction than the second width W₂ of the second layer. The first layer and third layer each has an overhang.

In another embodiment of the present disclosure, a method for making a heat exchanger includes forming a first layer including a first width W₁ extending in a sinusoidal shape in a first direction and a first length L₁ extending in a sinusoidal shape in a second direction. Forming a second layer including a second length L₂ extending in a sinusoidal shape in the first direction and a second width W₂ extending in a sinusoidal shape in the second direction. Forming a third layer that includes a third width W₃ extending in a sinusoidal shape in the first direction and a third length L₃ extending in a sinusoidal shape in the second direction. The second layer is between the first layer and the second layer. The first length L₁ of the first layer and the third length L₃ of the third layer both extend further in the second direction than the second width W₂ of the second layer. The first layer and the third layer each includes an overhang. The second length L₂ of the second layer extends further in the first direction than the first width W₁ of the first layer and the third width W₃ of the third layer. The second layer includes an overhang.

Persons of ordinary skill in the art will recognize that other aspects and embodiments are possible in view of the entirety of the present disclosure, including the accompanying figures.

### BRIEF DESCRIPTION OF THE DRAWINGS

FIG. 1 is a perspective view of a cross-section of a heat exchanger.

FIG. 2 is a cross-sectional side view of the heat exchanger.

### DETAILED DESCRIPTION

The disclosure relates to a cross-flow heat exchanger with overhangs on each layer. The overhangs help guide the fluid into passageways resulting in a decrease of the pressure drop across the heat exchanger. Additionally, the overhangs reduce the transient thermal stress of the heat exchanger by guiding the fluid into the passageways and insulating a large portion of the solid regions on the hot face of the heat exchanger.

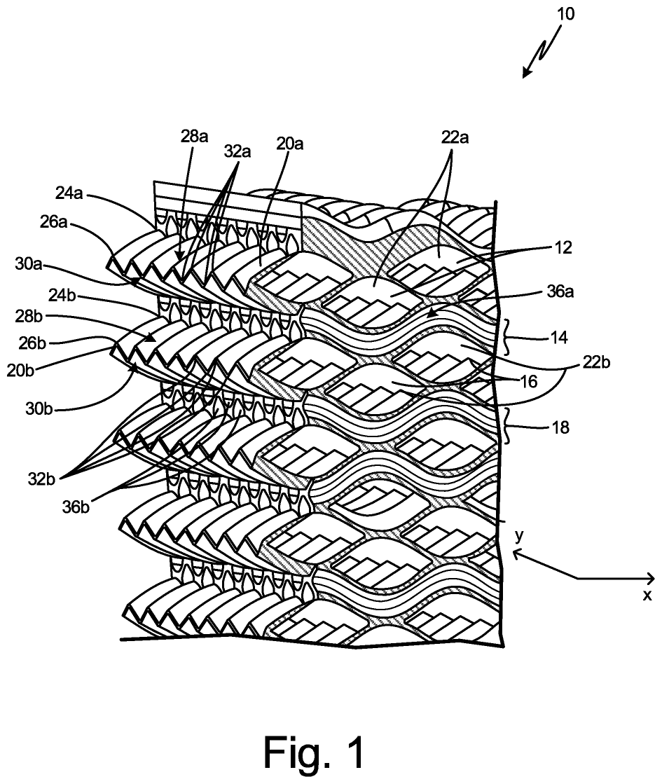

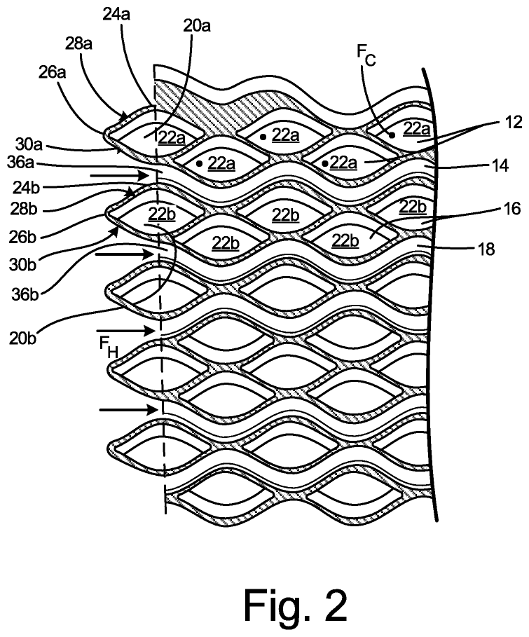

FIGS. 1 and 2 will be discussed concurrently. FIG. 1 is a perspective view of a cross-section of heat exchanger 10. FIG. 2 is a side view of a cross-section of heat exchanger 10. FIGS. 1 and 2 include first layer 12, second layer 14, third layer 16, and fourth layer 18. First layer 12, second layer 14, third layer 16, and fourth layer 18 can be made from many different materials including copper, titanium, stainless steel, aluminum, graphite, ceramics, composites, plastics, and/or any other material with a relatively high thermal conductivity. First layer 12, second layer 14, third layer 16, and fourth layer 18 can all be made from the same material, or each layer can be made of a different material.

In the embodiment of FIGS. 1 and 2, first layer 12, second layer 14, third layer 16, and fourth layer 18 each has a triangular edge with a curvature ratio extending in direction X and first layer 12, second layer 14, third layer 16, and fourth layer 18 each has a triangular edge with a curvature ratio extending in direction Y. In other embodiments, first layer 12, second layer 14, third layer 16, and fourth layer 18 each can have a sinusoidal wave shape, or any other repeating pattern extending in direction X and first layer 12, second layer 14, third layer 16, and fourth layer 18 each can have a sinusoidal wave shape, or any other repeating pattern extending in direction Y.

First layer 12 includes overhang 20a and a plurality of passages 22a. Second layer 14 includes a plurality of passages 36a. Third layer 16 includes overhang 20b (overhang 20a and overhang 20b are hereinafter referred to as “overhangs 20”) and a plurality of passages 22b (plurality of passages 22a and plurality of passages 22b are hereinafter referred to as “passages 22”). First layer 12 and third layer 16 each extend further in direction X than second layer 14 and fourth layer 18 each extend in direction X, thereby creating overhangs 20. Fourth layer 18 includes a plurality of passages 36b (plurality of passages 36a and plurality of passages 36b are hereinafter referred to as “passages 36”). Second layer 14 and fourth layer 18 can each extend further in direction Y than first layer 12 and third layer 16 to form overhangs (not shown) on second layer 14 and fourth layer 18. In the embodiment of FIGS. 1 and 2, first layer 12 and third layer 16 each guide cold fluid F_{C} through passages 22, while second layer 14 and fourth layer 18 each guide hot fluid F_{H} through passages 36. In another embodiment, first layer 12 and third layer 16 can each guide hot fluid F_{H} through passages 22, while second layer 14 and fourth layer 18 can each guide cold fluid F_{C} through passages 36.

Each overhang 20 includes base end 24, distal end 26, first surface 28, and second surface 30. First surface 28 of overhang 20 and second surface 30 of overhang 20 extend from base end 24 of overhang 20 and come together to a bullnose point at distal end 26 of overhang 20. In other embodiments, first surface 28 of overhang 20 and second surface 30 of overhang 20 can extend from base end 24 of overhang 20 and come together at distal end 26 of overhang 20 in many different shapes, such as a taper point, blunt taper point, taper cut, or any other convex point. First surface 28 of overhang 20 includes a plurality of troughs 32a. Second surface 30 of overhang 20 includes a plurality of troughs 32b (plurality of troughs 32a and plurality of troughs 32b hereinafter referred to as “troughs 32”).

Each of troughs 32 is aligned with one of passages 36 to direct hot fluid F_{H} flow from distal end 26 of overhang 20 into passages 36, thus making the transition from distal end 26 of overhang 20 to passages 36 as smooth as possible. Troughs 32a on first surface 28 are offset from troughs 32b of second surface 30 in direction Y. To enable a smooth transition from distal end 26 of overhang 20 to passages 36 troughs 32 increase in amplitude, or height, as troughs 36 extend toward base end of overhang 20. A smooth transition from distal end 26 of overhang 20 to passages 36 decreases the pressure drop across heat exchanger 10. Additionally, a smooth transition from distal end 26 of overhang 20 to passages 36 reduces the impingement of hot air on concave surfaces that expose heat exchanger 10 to transient thermal stresses. Reducing the transient thermal stresses caused the impingement of hot air can reduce permanent deformation in heat exchanger 10 and increase the operating life of heat exchanger 10.

During operation, hot fluid F_{H} can flow through first layer 12 and third layer 16, while cool fluid F_{C} can flow through second layer 14 and fourth layer 18. As hot fluid F_{H} approaches first layer 12 and third layer 16, hot fluid F_{H} will first contact distal end 26 of overhang 20. From distal end 26 troughs 32 can guide hot fluid F_{H} toward base end 24 of overhang 20. Once hot fluid F_{H} reaches base end 24, hot fluid F_{H} enters passages 36. Overhang 20 is configured to make the transition from distal end 26 of overhang 20 to passages 36 as smooth as possible to minimize the pressure loss of heat exchanger 10.

In manufacturing heat exchanger 10 there are many different options to build first layer 12, second layer 14, third layer 16, and fourth layer 18. Heat exchanger 10 can be made through additive manufacturing, which enables heat exchanger 10 to be a unitary monolithic component. Additive manufacturing also enables heat exchanger 10 to be manufactured in a single process step, potentially reducing manufacturing time and cost. In another embodiment, heat exchanger 10 could be joined through brazing, welding, soldering, and/or any other joining method used in the forming of heat exchangers.

### Discussion of Possible Embodiments

The following are non-exclusive descriptions of possible embodiments of the present invention.

In one embodiment of the present disclosure, a heat exchanger includes a first layer, a second layer, and a third layer. The first layer includes a first width W₁ extending in a first direction and a first length L₁ extending in a second direction. The second layer includes a second length L₂ extending in the first direction and a second width W₂ extending in the second direction. The third layer includes a third width W₃ extending in the first direction and a third length L₃ extending in a second direction. The second layer is between the first layer and the third layer. The first length L₁ of the first layer and the third length L₃ of the third layer both extend further in the second direction than the second width W₂ of the second layer. The first layer and the third layer each includes an overhang.

The heat exchanger of the preceding paragraph can optionally include, additionally and/or alternatively, any one or more of the following features, configurations and/or additional components:

the second length L₂ of the second layer extends further in the first direction than the first width W₁ of the first layer and the third width W₃ of the third layer, and wherein the second layer includes an overhang;

the second layer further includes at least one passage extending in the second direction, from an edge of the second layer, through an opposite edge of the second layer, wherein the overhang of the first layer and the overhang of the third layer is configured to direct an airflow into the at least one passage;

the overhang of the first layer further includes a sinusoidal curve in the first direction and a sinusoidal curve in the second direction;

the overhang of the third layer further comprises a sinusoidal curve in the first direction and a sinusoidal curve in the second direction;

the overhang of the second layer includes a sinusoidal curve in the first direction and a sinusoidal curve in the second direction;

the overhang of the first layer and the overhang of the third layer each includes a base end even with an edge of the second layer, a distal end opposite the base end, and the overhang tapers from the base end to the distal end;

a first surface extending from the base end to the distal end, a second surface extending from the base end to the distal end, where the first surface and the second surface meet at the distal end, and the first surface and the second surface are each corrugated;

an at least one trough on the first surface and at least one trough on the second surface, where in each of the at least one troughs extends from the distal end to the base end, and one of the at least one troughs is aligned with a passageway of the second layer;

a first surface extending from the base end to the distal end, a second surface extending from the base end to the distal end, where the first surface and the second surface meet at the distal end, and the first surface and the second surface are each triangular wave shaped; and/or

the first layer, the second layer, and the third layer are constructed by additive manufacturing so that the heat exchanger is one continuous monolithic component.

In another embodiment of the present disclosure, a heat exchanger includes a first layer, a second layer, and a third layer. The first layer includes a first width W₁ extending in a sinusoidal shape in a first direction and a length L₁ extending in a sinusoidal shape in a second direction. The second layer includes a second length L₂ extending in a sinusoidal shape in the first direction and a second width W₂ extending in a sinusoidal shape in the second direction. The third layer includes a third width W₃ extending in a sinusoidal shape in the first direction and a third length L₃ extending in a sinusoidal shape in the second direction. The second layer is between the first layer and the third layer. The first length L₁ of the first layer and the third length L₃ of the third layer both extend further in the second direction than the second width W₂ of the second layer. The first layer and third layer each comprise an overhang.

The heat exchanger of the preceding paragraph can optionally include, additionally and/or alternatively, any one or more of the following features, configurations and/or additional components:

the second length L₂ of the second layer extends further in the first direction than the first width W₁ of the first layer and the third width W₃ of the third layer, and wherein the second layer includes an overhang;

the overhang of the first layer and the overhang of the third layer includes a base, even with an edge of the second layer, where the base has a first amplitude, and a distal end opposite the base end, where the distal end includes a second amplitude;

the first amplitude of the base is greater than the second amplitude of the distal end; and/or

the first amplitude of the base and the second amplitude of the distal end are equal.

In another embodiment of the present disclosure, a method for making a heat exchanger includes forming a first layer including a first width W₁ extending in a sinusoidal shape in a first direction and a first length L₁ extending in a sinusoidal shape in a second direction. Forming a second layer including a second length L₂ extending in a sinusoidal shape in the first direction and a second width W₂ extending in a sinusoidal shape in the second direction. Forming a third layer includes a third width W₃ extending in a sinusoidal shape in the first direction and a third length L₃ extending in a sinusoidal shape in the second direction. The second layer is between the first layer and the second layer. The first length L₁ of the first layer and the third length L₃ of the third layer both extend further in the second direction than the second width W₂ of the second layer. The first layer and the third layer each include an overhang. The second length L₂ of the second layer extends further in the first direction than the first width W₁ of the first layer and the third width W₃ of the third layer. The second layer includes an overhang.

The method of making a heat exchanger of the preceding paragraph can optionally include, additionally and/or alternatively, any one or more of the following features, configurations and/or additional components:

forming a fourth layer having a fourth length L₄ extending in a sinusoidal shape in the first direction and a fourth width W₄ extending in a sinusoidal shape in the second direction;

additively manufacturing the first layer, the second layer, the third layer, and the fourth layer; and/or

the first layer, the second layer, the third layer, and the fourth layer are continuous and monolithic.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A heat exchanger comprising:
a first layer, comprising a first width W₁ extending in a first direction and a first length L₁ extending in a second direction;
a second layer, comprising a second length L₂ extending in the first direction and a second width W₂ extending in the second direction; and
a third layer, comprising a third width W₃ extending in the first direction and a third length L₃ extending in the second direction, wherein the second layer is between the first layer and the third layer, and wherein the first length L₁ of the first layer and the third length L₃ of the third layer both extend further in the second direction than the second width W₂ of the second layer, and the first layer and the third layer each comprises an overhang.

2. The heat exchanger of claim 1, wherein the second length L₂ of the second layer extends further in the first direction than the first width W₁ of the first layer and the third width W₃ of the third layer, and wherein the second layer comprises an overhang.

3. The heat exchanger of claim 2, wherein the second layer further comprises;
at least one passage extending in the second direction, from an edge of the second layer, through an opposite edge of the second layer, wherein the overhang of the first layer and the overhang of the third layer is configured to direct an airflow into the at least one passage.

4. The heat exchanger of claim 1, wherein the overhang of the first layer further comprises a sinusoidal curve in the first direction and a sinusoidal curve in the second direction.

5. The heat exchanger of claim 1, wherein the overhang of the third layer further comprises a sinusoidal curve in the first direction and a sinusoidal curve in the second direction.

6. The heat exchanger of claim 2, wherein the overhang of the second layer comprises a sinusoidal curve in the first direction and a sinusoidal curve in the second direction.

7. The heat exchanger of claim 1, wherein the overhang of the first layer and the overhang of the third layer each comprises:
a base end even with an edge of the second layer;
a distal end opposite the base end, wherein the overhang tapers from the base end to the distal end.

8. The heat exchanger of claim 7, further comprising:
a first surface extending from the base end to the distal end;
a second surface extending from the base end to the distal end, wherein the first surface and the second surface meet at the distal end, and wherein the first surface and the second surface are each corrugated.

9. The heat exchanger of claim 8, further comprising:
at least one trough on the first surface and at least one trough on the second surface, wherein each of the at least one troughs extends from the distal end to the base end, and wherein one of the at least one troughs is aligned with a passageway of the second layer.

10. The heat exchanger of claim 7, further comprising:
a first surface extending from the base end to the distal end;
a second surface extending from the base end to the distal end, wherein the first surface and the second surface meet at the distal end, and wherein the first surface and the second surface are each triangular wave shaped.

11. The heat exchanger of claim 1, wherein the first layer, the second layer, and the third layer are constructed by additive manufacturing so that the heat exchanger is one continuous and monolithic component.

12. A heat exchanger comprising:
a first layer, comprising a first width W₁ extending in a sinusoidal shape in a first direction and a first length L₁ extending in sinusoidal shape in a second direction;
a second layer, comprising a second length L₂ extending in a sinusoidal shape in the first direction and a second width W₂ extending in a sinusoidal shape in the second direction; and
a third layer, comprising a third width W₃ extending in a sinusoidal shape in the first direction and a third length L₃ extending in a sinusoidal shape in the second direction, wherein the second layer is between the first layer and the second layer, and wherein the first length L₁ of the first layer and the third length L₃ of the third layer both extend further in the second direction than the second width W₂ of the second layer, and the first layer and the third layer each comprise an overhang.

13. The heat exchanger of claim 12 wherein the second length L₂ of the second layer extends further in the first direction than the first width W₁ of the first layer and the third width W₃ of the third layer, and wherein the second layer comprises an overhang.

14. The heat exchanger of claim 12, wherein the overhang of the first layer and the overhang of the third layer comprises:
a base, even with an edge of the second layer, wherein the base end comprises a first amplitude;
a distal end opposite the base end, wherein the distal end comprises a second amplitude.

15. The heat exchanger of claim 13, wherein the first amplitude of the base is greater than the second amplitude of the distal end.

16. The heat exchanger of claim 13, wherein the first amplitude of the base and the second amplitude of the distal end are equal.

17. A method of making a heat exchanger, the method comprising:
forming a first layer comprising a first width W₁ extending in a sinusoidal shape in a first direction and a first length L₁ extending in a sinusoidal shape in a second direction;
forming a second layer comprising a second length L₂ extending in a sinusoidal shape in the first direction and a second width W₂ extending in a sinusoidal shape in the second direction; and
forming a third layer comprising a third width W₃ extending in a sinusoidal shape in the first direction and a third length L₃ extending in a sinusoidal shape in the second direction, wherein the second layer is between the first layer and the second layer, and wherein the first length L₁ of the first layer and the third length L₃ of the third layer both extend further in the second direction than the second width W₂ of the second layer and the first layer and the third layer each comprise an overhang, and the second length L₂ of the second layer extends further in the first direction than the first width W₁ of the first layer and the third width W₃ of third layer, and wherein the second layer comprises an overhang.

18. The method of claim 17, further comprising:
forming a fourth layer comprising a fourth length L₄ extending in a sinusoidal shape in the first direction and a second width W₂ extending in a sinusoidal shape in the second direction.

19. The method of claim 17, further comprising:
additively manufacturing the first layer, the second layer, the third layer, and the fourth layer.

20. The method of claim 17, wherein the first layer, the second layer, the third layer, and the fourth layer are continuous and monolithic.
